(19) United States
(12) Patent Application Publication
(10) Pub. No.: US 2025/0043105 A1
(43) Pub. Date: Feb. 6, 2025

(54) RESINS INCLUDING COVALENTLY BOUND FILLERS AND METHODS OF USING THE SAME IN ADDITIVE MANUFACTURING

(71) Applicant: Carbon, Inc., Redwood City, CA (US)

(72) Inventors: David Hernandez, San Mateo, CA (US); Andrew Gordon Wright, Mountain View, CA (US)

(21) Appl. No.: 18/788,298

(22) Filed: Jul. 30, 2024

Related U.S. Application Data
(60) Provisional application No. 63/516,639, filed on Jul. 31, 2023.

(51) Int. Cl. C08K 5/00; B29C 64/124; B29C 64/30; B29K 75/00; B29K 105/00; B29K 105/16; B29K 505/00; B33Y 10/00; B33Y 40/20; B33Y 70/10; C08G 18/48; C08G 18/67; C08G 18/73

(52) U.S. Cl. CPC C08K 5/0091; B29C 64/124; B29C 64/30; B33Y 10/00; B33Y 40/20; B33Y 70/10; C08G 18/4829; C08G 18/4854; C08G 18/672; C08G 18/673; C08G 18/73; B29K 2075/00; B29K 2105/0005; B29K 2105/16; B29K 2505/00; B29K 2995/0025; C08K 2201/003

(57) ABSTRACT

Resin compositions are provided for producing a three-dimensional object by additive manufacturing that include at least one reactive compound having a filler moiety covalently attached (bonded) thereto. In some embodiments, the reactive compound may be a monomer, a prepolymer, a chain extender, and/or a reactive diluent. In certain embodiments, more than one type of reactive compound may include a filler moiety covalently attached thereto.

### CROSS-REFERENCE TO RELATED APPLICATIONS

This application claims priority from U.S. Provisional Application No. 63/516,639, filed Jul. 31, 2023, the disclosure of which is hereby incorporated by reference in its entirety.

### FIELD

The present invention relates to resin compositions useful for additive manufacturing and methods of using the same.

### BACKGROUND

In conventional additive or three-dimensional fabrication techniques, construction of a three-dimensional object is performed in a step-wise or layer-by-layer manner. Typically, layer formation is performed through solidification of photo curable resin under the action of visible or UV light irradiation. Generally referred to as “stereolithography,” two particular techniques are known: one in which new layers are formed at the top surface of the growing object; the other in which new layers are formed at the bottom surface of the growing object. Examples of such methods include those given in U.S. Pat. No. 5,236,637 to Hull (see, e.g., FIGS. 3-4), U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and U.S. Patent Application Publication No. 2013/0295212 to Chen et al.

Techniques referred to as “continuous liquid interface production” (or “CLIP”) have also been developed. These techniques enable the rapid production of three-dimensional objects in a layerless manner, by which the parts may have desirable structural and mechanical properties. See, e.g., U.S. Pat. Nos. 9,211,678, 9,205,601, and 9,216,546; J. Tumbleston et al., Continuous liquid interface production of 3D Objects, Science 347, 1349-1352 (2015); and R. Janusziewcz et al., Layerless fabrication with continuous liquid interface production, Proc. Natl. Acad. Sci. USA 113, 11703-11708 (2016).

Dual cure stereolithography resins suitable for stereolithography techniques are described, for example, in U.S. Pat. Nos. 9,453,142, 9,676,963, and 9,598,606. Such resins typically include a first polymerizable system polymerized by light (sometimes referred to as “Part A”) from which an intermediate object is produced, and also include at least a second polymerizable system (“Part B”) which is usually cured after the intermediate object is first formed, and which imparts desirable structural and/or tensile properties to the final object.

### SUMMARY

In conventional additive manufacturing techniques, liquid resins are used and it is generally desirable for the resins to have a relatively low viscosity. This may allow for easier handling of the resin, lower printing forces during printing, faster resin flow to refill depleted/printed regions, as well as easier-to-clean printed parts. To provide color and/or stability to the resins and objects formed therefrom, fillers such as polymer particles, pigments, dyes, and the like, may be included in the resin. For example, to control opacity and/or incorporate a white or ‘milky white’ color, either for the final printed object aesthetic (visible light scattering) or for printability control (UV light scattering), high density pigments such as titanium dioxide may be added. Similarly, for modifying mechanical properties or reducing costs, solid filler particles may be added. However, the relatively low viscosity of the resins may be detrimental to the dispersibility and stability of pigments and fillers due to differences in densities and/or chemical incompatibilities of the surfaces of particles and the resin matrix. For example, as resin viscosity decreases, flocculation and/or sedimentation may be more likely to occur over time and such processes may sometimes be irreversible. Such flocculation and/or sedimentation may have a significant negative impact on print accuracy and the resulting mechanical properties of an additively manufactured object.

To solve the aforementioned problems, the inventors have unexpectedly discovered that filler moieties may be covalently attached to monomers and/or other reactants participating in the polymerization/curing process in order to reduce or prevent settling of the filler in the resin. Such filler moieties do not impede the polymerization reaction(s) and may provide desirable mechanical and/or scattering properties in the resultant additively manufactured object. In doing so, the resins and products formed therefrom may benefit from the inclusion of fillers (e.g., light scattering, color, or mechanical properties) while avoiding the difficulties that occur with traditional fillers, e.g., flocculation and/or sedimentation.

Accordingly, provided according to some embodiments of the invention are resin compositions for producing a three-dimensional object by additive manufacturing that include at least one reactive compound having a filler moiety (e.g., an organic filler moiety or an inorganic filler moiety) covalently attached (bonded) thereto. In some embodiments, the reactive compound may be a monomer, a prepolymer, a chain extender, and/or a reactive diluent. In certain embodiments, more than one type of reactive compound may include a filler moiety covalently attached thereto.

In some embodiments of the invention, the filler moiety scatters light in a range of 100 nm to 700 nm (optionally, in a range of about 400 nm to about 700 nm). In some embodiments, the filler moiety has an average diameter in a range of about 0.1 μm to about 200 μm.

In some embodiments of the invention, the filler moiety covalently attached to the reactive compound is an organic filler moiety (e.g., a copolymer of styrene and acrylonitrile). In some embodiments, the filler moiety is an inorganic filler moiety (e.g., a silica-based particle).

In some embodiments of the invention, the resin composition includes precursors to a polyurethane, polyurea, polyisocyanurate, a silicone resin, an epoxy resin, a cyanate ester resin, or a combination of any of the foregoing. In some embodiments, the resin composition is a dual cure resin.

In some embodiments of the invention, the filler moiety is covalently attached to a light polymerizable monomer (e.g., an acrylate, methacrylate, α-olefin, N-vinyl, acrylamide, methacrylamide, styrenic, epoxides, thiol, 1,3-diene, vinyl halide, acrylonitrile, vinyl ester, maleimide, and vinyl ether).

In some embodiments of the invention, the filler moiety is covalently attached to a prepolymer and/or chain extender and the resin composition reacts to form one or more of a polyurethane, a polyurea and a polyisocyanurate. In some embodiments, the prepolymer is a blocked or reactive blocked prepolymer and/or the chain extender is a blocked or reactive blocked chain extender. In certain embodiments, the chain extender includes a polyamine and/or a polyol. In particular embodiments, the resin composition includes (a) a prepolymer blocked with reactive blocking groups and comprising the filler moiety covalently attached thereto; (b) a chain extender; (c) a photoinitiator; and (d) optionally, a reactive diluent.

In some embodiments of the invention, the resin composition is devoid of (or substantially devoid of, e.g., less than 0.1 wt %) one or more of (a) a non-covalently bound filler, (b) a non-covalently bound pigment, and (c) a non-covalently bound dye. In some embodiments, despite the resin being devoid of any or all of such components, the resin, the intermediate formed therefrom, and/or the three-dimensional object formed therefrom may be opaque and/or white.

Also provided according to some embodiments of the invention are methods of forming a three-dimensional object that include irradiating a resin composition of the invention (e.g., using a top-down or bottom-up stereolithography method) thereby forming the three-dimensional object.

In some embodiments of the invention, methods include the steps of (a) providing a carrier and an optically transparent member having a build surface, the carrier and the build surface defining a build region therebetween; (b) filling the build region with a resin composition of the invention; (c) irradiating the build region with light through the optically transparent member to solidify at least a portion of the resin composition; (d) advancing the carrier away from the build surface; (e) repeating steps (b) through (d) to form a solid polymer scaffold; and (f) optionally, washing the solid polymer scaffold, thereby forming the three-dimensional object.

In some embodiments, the solid polymer scaffold is a three-dimensional intermediate having the same shape as, or a shape to be imparted to, the three-dimensional object, and the three-dimensional intermediate is further reacted to form the three-dimensional object. In some embodiments, further reacting includes heating, microwave irradiation, irradiation at a same or different wavelength than in step (c), and/or exposure to moisture. In some embodiments, the resin composition is a dual cure resin and wherein the three-dimensional intermediate carries unsolidified and/or uncured resin within the solid polymer scaffold and the further reacting solidifies the unsolidified and/or uncured resin. In some embodiments, further reacting is carried out under conditions in which the polymer scaffold degrades and forms a constituent necessary for the solidification or curing of the unsolidified and/or uncured resin.

In some embodiments of the invention, step (b) and/or step (c) is carried out while also concurrently (i) continuously maintaining a dead zone of the resin composition in contact with the build surface; and (ii) continuously maintaining a gradient of polymerization zone between the dead zone and solidified polymer in contact with the carrier, the gradient of polymerization zone comprising the resin composition in partially cured form. In some embodiments, the optically transparent member includes a semipermeable member (optionally wherein the semipermeable member comprises a fluoropolymer), and continuously maintaining a dead zone is carried out by feeding an inhibitor (e.g., oxygen) through the optionally transparent member, optionally creating a gradient of inhibitor in the dead zone and optionally in at least a portion of the gradient of polymerization zone.

Also provided is a three-dimensional object formed from a resin composition as taught herein.

### DETAILED DESCRIPTION

The present invention is now described more fully hereinafter with reference to embodiments. This invention may, however, be embodied in many different forms and should not be construed as limited to the embodiments set forth herein; rather, these embodiments are provided so that this disclosure will be thorough and complete and will fully convey the scope of the invention to those skilled in the art.

The terminology used herein is for the purpose of describing particular embodiments only and is not intended to be limiting of the invention. As used herein, the singular forms “a,” “an” and “the” are intended to include plural forms as well, unless the context clearly indicates otherwise. It will be further understood that the terms “comprises” or “comprising,” when used in this specification, specify the presence of stated features, integers, steps, operations, elements components and/or groups or combinations thereof, but do not preclude the presence or addition of one or more other features, integers, steps, operations, elements, components and/or groups or combinations thereof. The sequence of operations (or steps) is not limited to the order presented in the claims or figures unless specifically indicated otherwise. Any element that comprises certain features, integers, steps, operations, elements, components and/or groups may also “consist of” or “consist essentially of” such features, integers, steps, operations, elements, components and/or groups, respectively.

As used herein, the term “and/or” includes any and all possible combinations or one or more of the associated listed items, as well as the lack of combinations when interpreted in the alternative (“or”).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and claims and should not be interpreted in an idealized or overly formal sense unless expressly so defined herein. Well-known functions or constructions may not be described in detail for brevity and/or clarity.

It will be understood that, although the terms first, second, etc., may be used herein to describe various elements, components, regions, layers and/or sections, these elements, components, regions, layers and/or sections should not be limited by these terms. Rather, these terms are only used to distinguish one element, component, region, layer and/or section, from another element, component, region, layer and/or section. Thus, a first element, component, region, layer, or section discussed herein could be termed a second element, component, region, layer or section without departing from the teachings of the present invention.

All publications and patents cited herein are specifically incorporated by reference to disclose the methods and/or materials with which the documents are cited.

As used herein, the term “about” with reference to a numerical number or range refers to the exact numbers and to values that are +/−1%, 2%, 5%, or 10% thereof. It is also to be understood that where a range of values is provided, each intervening integer within the upper and lower limit of the range is also explicitly disclosed.

As used herein, when a particle is not spherical, the diameter of the particle is defined as the longest dimension of the particle

“Shape to be imparted to” refers to the case where the shape of the intermediate object slightly changes between formation thereof and forming the subsequent three-dimensional product, typically by shrinkage (e.g., up to 1, 2 or 4 percent by volume), expansion (e.g., up to 1, 2 or 4 percent by volume), removal of support structures, or by intervening forming steps (e.g., intentional bending, stretching, drilling, grinding, cutting, polishing, or other intentional forming after formation of the intermediate product, but before formation of the subsequent three-dimensional product).

As used herein, the term “monomer” refers to compound that can react with other monomer molecules to form a prepolymer or polymer. A “reactive diluent,” as used herein, is a type of monomer that may be included in a resin composition and polymerizes during exposure to actinic radiation or light (e.g., via free radical polymerization).

As used herein, the term “prepolymer” refers to an oligomer or polymer (e.g., has a Mw in a range of 250 to 10,000 g/mol) that may further react (e.g., with a chain extender) to form a longer polymer chain and/or a polymer network. Non-limiting examples include polyisocyanate prepolymers, polyurethane prepolymers, polyurea prepolymers, and polyisocyanurate prepolymers.

As used herein, the term “chain extender” refers to a compound (e.g., a single compound, an oligomer, or polymer) that may react with prepolymer to convert the prepolymer to higher molecular weight chains and/or polymer networks. Non-limiting examples of chain extenders include polyamines (e.g., diamines, triamines, etc.) and polyols (e.g., diols, triols, etc.).

As used herein, the term “filler moiety” refers to a compound (e.g., an oligomer, polymer, and/or condensed macromolecular structure) that is (a) bound to at least one (but in some cases, a plurality of) reactive compound(s), (b) of sufficient size and shape to scatter light in a range of about 100 to about 700 nm (in some embodiments, in a range of about 400 to about 700 nm), and (c) and is retained in some form in the final object formed by additive manufacturing. An “organic filler moiety” is substantially (e.g., 80%, 85%, 90%, 95%, 99% by weight) or completely formed of organic component(s). An “inorganic filler moiety” is substantially (e.g., 80%, 85%, 90%, 95%, 99% by weight) or completely formed of inorganic component(s).

As used herein, the term “(meth)acrylate” includes a methacrylate and/or an acrylate. Likewise, the term “di(meth)acrylate” includes a dimethacrylate and/or a diacrylate.

### RESIN COMPOSITIONS

Provided according to some embodiments of the invention are resin compositions for producing a three-dimensional object by additive manufacturing. Such resin compositions include at least one reactive compound having a filler moiety (e.g., an organic filler moiety or an inorganic filler moiety) covalently attached (bonded) thereto. Such compositions may also be referred to herein as a “polymerizable liquid,” “liquid resin,” “ink,” or simply “resin.” The reactive compound is a compound that reacts to form part of the polymer chains and/or polymer network that forms the additively manufactured three-dimensional object and may include, for example, a monomer, prepolymer, a chain extender, and/or a reactive diluent.

In particular embodiments, a resin composition of the invention is devoid of (or substantially devoid of) one or more of: (a) a filler that is not covalently bonded to a reactive compound (also referred to herein as a “non-covalently bound filler”), (b) a pigment that is not covalently bonded to a reactive compound (also referred to herein as a “non-covalently bound pigment”), and (c) a dye that is not covalently bonded to a reactive compound (also referred to herein as a “non-covalently bound dye”). As such, in some embodiments, the resin composition may include a non-covalently bound filler, such as, for example, a filler that modifies the mechanical characteristics of the resin or object, but be devoid or substantially devoid of non-covalently bound pigments and/or non-covalently bound dyes. In some embodiments, despite the lack of such non-covalently bound pigments and dyes, such resins may polymerize to form an intermediate and/or final object that is opaque, white, and/or colored. In other embodiments, the resin compositions may be devoid or substantially devoid of a non-covalently bound filler, a non-covalently bound pigment, and a non-covalently bound dye. However, in such some embodiments, such resins may result in an intermediate and/or final object that is opaque, white, and/or colored.

### FILLER MOIETY

A number of possible filler moieties may be used in resin compositions of the invention. In general, the filler moiety is a molecule (e.g., an oligomer, polymer, and/or condensed macromolecular structure) that has been traditionally added to a resin composition in its free and unbound form to alter the mechanical properties, opacity and/or color of an intermediate and/or final object formed by additive manufacturing. However, in the present invention, the filler moiety is covalently bound to a reactive compound so that the filler moiety is retained, either in the same or substantially similar form (or modified form in some embodiments) in the resultant three dimensional intermediate and/or object.

In some embodiments, the filler moiety is an organic filler moiety. In some embodiments, the organic filler moiety comprises a polymer or copolymer, such as, for example, a polymer including styrenic, acrylic, methacrylic, nitrile, amide, and/or ester subunits. In some embodiments, the organic filler moiety is a polymer formed from monomers selected from styrenes, esters of acrylic and methacrylic acids, ethylenically unsaturated nitriles and amides, and combinations thereof. In some embodiments, the organic filler moiety is a polymer formed from styrenes, ethylenically unsaturated nitriles and amides, and combinations thereof. In some embodiments, the organic filler moiety is formed from styrene and acrylonitrile. Examples of the styrenes include, but are not limited to, styrene, para-methyl styrene, and combinations thereof. Examples of ethylenically unsaturated nitriles and amides include, but are not limited to, acrylonitrile, methacrylonitrile, acrylamide, and combinations thereof.

In some embodiments, about 25% to about 50% of the total weight of the monomer used to form the organic filler moiety is acrylonitrile, alternatively from about 30% to about 40%, alternatively from about 30% to about 35%, and alternatively about 33%. In other embodiments, about 50% to about 75% of the total weight of the monomer used to form the organic filler moiety is styrene, alternatively from about 60% to about 70%, alternatively from about 65% to about 70%, and alternatively about 66%. In certain embodiments, the filler moiety comprises a ratio of 1 to 3 acrylonitrile (AN) to styrene (Sty) (i.e., 1AN:3Sty), alternatively 3AN:1Sty, 2AN:1Sty, 1AN:2Sty, or 1AN:1Sty. In these embodiments, the filler moieties may be referred to as styrene-acrylonitrile (SAN) or SAN copolymer particles. The SAN copolymer particles may include various ratios of AN to Sty, such as different ratios falling between, above, or below the monomer ratios expressly described herein. In some embodiments, the organic filler moiety includes or is formed from a polyol described in U.S. Pat. No. 9,230,346, incorporated by reference herein in its entirety.

In some embodiments, the filler moiety is an inorganic filler moiety. In some embodiments, the inorganic filler moiety includes a silica-based particle, including, for example, a silica particle wherein the surface is functionalized for example, with a (meth)acrylate, hydroxyl, amine, isocyanate, and the like, to form the filler moiety that reacts with a reactive compound or is itself the reactive compound (e.g., a methacrylate functional silica particle). One non-limiting example is ADMANANOR® silica-based compounds produced by Admatechs Company Limited (Aichi, Japan).

In some embodiments of the invention, the filler moiety is an organic or inorganic moiety that is present in particulate form. In some embodiments, the particulate filler moiety has an average diameter in a range of about 0.02 μm to about 200 μm. In some embodiments, the average diameter is in a range of about 0.02 μm, about 1 μm, or about 5 μm, to about 15 μm, about 25 μm, about 50 μm, about 100 μm, or about 150 μm. In some embodiments, the average diameter is about 0.02 μm, about 1 μm, about 5 μm, about 10 μm, about 12 μm, or about 15 μm, or any range defined therebetween. In some embodiments, the average diameter is about 25 μm, about 50 μm, about 75 μm, about 100 μm, about 150 μm, about 175 μm, about 200 μm, or any range defined therebetween.

In some embodiments of the invention, the resin composition includes covalently bound filler at a concentration in a range of about 0.5% to about 5% by weight, including about 1% to about 2% or about 3% by weight (e.g., 0.5%, 1%, 1.5%, 2%, 2.5%, 3%, 3.5%, 4%, 4.5%, or 5% by weight, or any range defined therebetween).

### MONOMERS, PREPOLYMERS, CHAIN EXTENDERS AND REACTIVE DILUENTS

The filler moiety may be covalently attached to a variety of reactive compounds including a variety of monomers, prepolymers, chain extenders and/or reactive diluents. In some embodiments, the resin composition includes precursors (e.g., monomers, prepolymers, chain extenders) to a polyurethane, polyurea, or copolymer thereof; a silicone resin; an epoxy resin; a cyanate ester resin; or any combination thereof, and the filler moiety is attached to one or more of such precursors. In some embodiments, at least a portion of the monomers, prepolymers and/or reactive diluents are photopolymerizable and/or free radically polymerizable. In some embodiments, at least a portion of the monomers, prepolymers, and/or chain extenders are polymerized by heating, microwave irradiation, irradiation at a same or different wavelength than in step (c), and/or exposure to moisture. In some embodiments, the resin composition has a UV reactive monomer and/or the reactive compound (having a filler moiety bonded thereto) polymerizes by exposure to actinic radiation or light (or reacts with both actinic radiation/light and heat).

The filler moiety may be attached to the reactive compound by any suitable method. For example, in some embodiments, a filler moiety having one or more (including 2, 3, 4, 5, etc.) alcohol or an amine functional group(s) may react with one or more (including 2, 3, 4, 5, etc.) isocyanate molecules to form a prepolymer. In some cases, the prepolymer may be a reactive prepolymer (e.g., a (meth)acrylate blocked polyurethane prepolymer). Such a prepolymer may polymerize, in some embodiments, upon exposure to actinic radiation or light. In certain cases, such a prepolymer may be part of a dual cure resin composition, such that, e.g., a chain extender is also present in the resin composition. In some embodiments, a filler moiety may react with a (meth)acrylate or vinyl monomer so that when such monomers are polymerized, the filler moiety is pendant from the polymer chain. The filler moiety may be bound, in some cases, to more than one reactive compound or multiple portions of a single reactive compound, for example, if the filler moiety is multi-functional (e.g., di-or tri-functional).

In some embodiments, the filler moiety is attached to a light polymerizable monomer and/or reactive diluent including but not limited to an acrylate, methacrylate, α-olefin, N-vinyl, acrylamide, methacrylamide, styrenic, epoxides, thiol, 1,3-diene, vinyl halide, acrylonitrile, vinyl ester, maleimide, vinyl ether, or any combination thereof. Additional monomers that may be used, include but are not limited to, those set forth in U.S. Pat. Nos. 8,232,043, 8,119,214, 7,935,476, 7,767,728, and 7,649,029. Examples include, but are not limited to, acrylics, methacrylics, acrylamides, styrenics, olefins, halogenated olefins, cyclic alkenes, maleic anhydride, alkenes, alkynes, functionalized oligomers, multifunctional cute site monomers, functionalized PEGs, etc., including combinations thereof. Examples of liquid resins, monomers and initiators include but are not limited to those set forth in U.S. Pat. Nos. 8,232,043, 8,119,214, 7,935,476, 7,767,728, and 7,649,029.

In some embodiments, the filler moiety is covalently bound to a prepolymer and/or chain extender and at least a portion of the resin composition reacts to form a polyurethane, polyurea, and/or polyisocyanurate. In some embodiments, the prepolymer is a blocked or reactive blocked prepolymer and/or the chain extender is a blocked or reactive blocked chain extender.

In some embodiments of the present invention, the prepolymer includes a polyurethane prepolymer, a polyurea prepolymer, a polyisocyanurate, or a combination thereof. In some embodiments, the blocked or reactive blocked prepolymer includes a polyisocyanate. In some embodiments, the reactive blocked prepolymer includes reactive end groups including, for example, acrylates, methacrylates, alpha-olefins, N-vinyls, acrylamides, methacrylamides, styrenics, epoxides, thiols, 1,3-dienes, vinyl halides, acrylonitriles, vinyl esters, maleimides, and vinyl ethers. In some embodiments, the reactive blocking group includes an amine (meth)acrylate monomer blocking agent (e.g., tertiary-butylaminoethyl methacrylate (TBAEMA), tertiary pentylaminoethyl methacrylate (TPAEMA), tertiary hexylaminoethyl methacrylate (THAEMA), tertiary-butylaminopropyl methacrylate (TBAPMA), tertiary-octylaminoethyl methacrylate (TOAEMA), acrylate analogs thereof, and mixtures thereof). In some embodiments, the reactive blocking group includes a vinyl amide blocking agent such as N-vinylformamide (NVF) or N-vinylacetamide (NVA). In some embodiments, the reactive blocked prepolymer includes a (meth)acrylate-blocked prepolymer. In some embodiments, the reactive blocked prepolymer includes a vinylamide blocked polyisocyanate.

In some embodiments, the prepolymer includes blocked polyisocyanates. Polyisocyanates (including diisocyanates) useful in carrying out the present invention include, but are not limited to, 1,1′-methylenebis(4-isocyanatobenzene) (MDI), 2,4-diisocyanato-1-methylbenzene (TDI), methylene-bis(4-cyclohexylisocyanate) (H12MDI), hexamethylene diisocyanate (HDI), isophorone diisocyanate (IPDI), 2,2,4-(2,4,4-) trimethylhexane 1,6-diisocyanate (TMHDI, e.g., VESTANAT® TMDI, available from Evonik (Essen, Germany)), polymeric MDI, 1,4-phenylene diisocyanate (PPDI), and o-tolidine diisocyanate (TODI). A preferred diisocyanate in some embodiments is H12MDI, such as Desmodur® W, supplied by Covestro AG (Leverkusen, Germany). Additional examples include but are not limited to those given in U.S. Pat. No. 3,694,389.

Examples of diol or polyol (e.g., triol) chain extenders include, but are not limited to, ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, hydroquinone bis(2-hydroxyethyl) ether (HQEE), glycerol, trimethylolpropane, 1,2,6-hexanetriol, and pentaerythritol. Natural oil polyols (biopolyols) may also be used. Such polyols may be derived, e.g., from vegetable oils (triglycerides), such as soybean oil, by known techniques. See, e.g., U.S. Pat. No. 6,433,121. Alkoxylates such as ethoxylates, propoxylates, butoxylates, etc., of diols, triols and higher polyalcohols may also be used, for example, trimethylolpropane ethoxylate.

In some embodiments, the resin composition includes a reactive blocked prepolymer having the filler moiety covalently attached thereto; a di(meth)acrylate (e.g., a polyalkylene glycol dimethacrylate); a (meth)acrylate diluent; a polyamine or polyol; and wherein the organic filler moiety is a copolymer comprising styrene and acrylonitrile units.

In some embodiments, the resin compositions include monomers that contain groups suitable for acid catalysis, such as epoxide groups, vinyl ether groups, etc. Thus, suitable monomers include olefins such as methoxyethene, 4-methoxystyrene, styrene, 2-methylprop-1ene, 1,3-butadiene, etc.; heterocycloic monomers (including lactones, lactams, and cyclic amines) such as oxirane, thietane, tetrahydrofuran, oxazoline, 1,3, dioxepane, oxetan-2-one, etc., and combinations thereof. A suitable (generally ionic or non-ionic) photoacid generator (PAG) is included in the acid catalyzed polymerizable liquid, examples of which include, but are not limited to onium salts, sulfonium and iodonium salts, etc., such as diphenyl iodide hexafluorophosphate, diphenyl iodide hexafluoroarsenate, diphenyl iodide hexafluoroantimonate, diphenyl p-methoxyphenyl triflate, diphenyl p-toluenyl triflate, diphenyl p-isobutylphenyl triflate, diphenyl p-tert-butylphenyl triflate, triphenylsulfonium hexafluororphosphate, triphenylsulfonium hexafluoroarsenate, triphenylsulfonium hexafluoroantimonate, triphenylsulfonium triflate, dibutylnaphthylsulfonium triflate, etc., including mixtures thereof. See, e.g., U.S. Pat. Nos. 7,824,839, 7,550,246, 7,534,844, 6,692,891, 5,374,500, and 5,017,461; see also Photoacid Generator Selection Guide for the electronics industry and energy curable coatings (BASF 2010).

In some embodiments, the monomers include those used for the formation of photocurable hydrogels, such as, e.g., poly(ethylene glycols) (PEG) and gelatins. In some embodiments, the resin composition includes monomers for photocurable silicones. UV cure silicone rubber, such as Siliopren™ UV Cure Silicone Rubber (Momentive Performance Materials Inc., Niskayuna, New York, U.S.A.) can be used as can LOCTITE® Cure Silicone adhesives sealants (Henkel Corp., Bridgewater, New Jersey, U.S.A.). Biodegradable resins are particularly important for implantable devices to deliver drugs or for temporary performance applications, like biodegradable screws and stents (see, e.g., U.S. Pat. Nos. 7,919, 162 and 6,932,930). Biodegradable copolymers of lactic acid and glycolic acid (PLGA) may be dissolved in PEG dimethacrylate to yield a transparent resin suitable for use. Polycaprolactone and PLGA oligomers may be functionalized with acrylic or methacrylic groups to allow them to be effective resins for use.

In some embodiments, monomers or prepolymers include, but are not limited to compounds having the following reactive group combinations: epoxy/amine, epoxy/hydroxyl, oxetane/amine, oxetane/alcohol, isocyanate*/hydroxyl, isocyanate*/amine, isocyanate/carboxylic acid, anhydride/amine, amine/carboxylic acid, amine/ester, hydroxyl/carboxylic acid, hydroxyl/acid chloride, amine/acid chloride, vinyl/Si—H (hydrosilylation), Si—Cl/hydroxyl, Si—Cl/amine, hydroxyl/aldehyde, amine/aldehyde, hydroxymethyl or alkoxymethyl amide/alcohol, aminoplast, alkyne/azide (also known as one embodiment of “Click Chemistry,” along with additional reactions including thiolene, Michael additions, Diels-Alder reactions, nucleophilic substitution reactions, etc.), alkene/Sulfur (polybutadiene vulcanization), alkene/thiol, alkyne/thiol, hydroxyl/halide, isocyanate*/water (polyurethane foams), Si—OH/hydroxyl, Si—OH/water, Si—OH/Si—H (tin catalyzed silicone), Si—OH/Si—OH (tin catalyzed silicone), perfluorovinyl (coupling to form perfluorocyclobutane), diene/dienophiles for Diels-Alder reactions, olefin metathesis polymerization, olefin polymerization using Ziegler-Natta catalysis, ring-opening polymerization (including ring-opening olefin metathesis polymerization, lactams, and lactones, siloxanes, epoxides, cyclic ethers, imines, cyclic acetals, etc.), where “*isocyanate” includes protected isocyanates (e.g. oximes).

In some embodiments, diluents for use in the present invention include reactive and/or non-reactive diluents. As described above, reactive diluents include monomers that will degrade, isomerize, cross-react, or polymerize, with themselves or other light polymerizable monomers during additive manufacturing. In some embodiments, the reactive diluent includes an acrylate, a methacrylate, a styrene, a vinylamide, a vinyl ether, a vinyl ester, or a combination of one or more of the foregoing (e.g., acrylonitrile, styrene, divinyl benzene, vinyl toluene, methyl acrylate, ethyl acrylate, butyl acrylate, methyl (meth)acrylate, isoboryl acrylate (IBOA), isobornyl methacrylate (IBOMA), 4-t-butyl-cyclohexyl (meth)acrylate, cyclic trimethylolpropane formal (meth)acrylate, 3,3,5-trimethylcyclohexyl (meth)acrylate, tricyclodecane dimethanol di (meth)acrylate, an alkyl ether of mono-, di-or triethylene glycol acrylate or methacrylate, a fatty alcohol acrylate or methacrylate such as lauryl (meth)acrylate, and mixtures thereof), TBAEMA (tert-butyl amino ethyl methacrylate), tetrahydrofurfuryl methacrylate, N,N-dimethylacrylamide, N-vinyl-2-pyrrolidone, N-vinylformamide, and Michael adducts of N-vinylformamide with (meth)acrylates (known and described in, for example, U.S. Pat. No. 5,672,731).

In general, the diluent(s) are included in an amount sufficient to reduce the viscosity of the polymerizable liquid or resin (e.g., to not more than about 15,000, about 10,000, about 6,000, about 5,000, about 4,000, or about 3,000 centipoise at about 25° C.). The diluent may be included in the polymerizable liquid in any suitable amount, typically from about 1, about 5 or about 10 percent by weight, up to about 30 or about 40 percent by weight, or more.

### OTHER RESIN COMPONENTS

The resin compositions may include other components as needed for the particular application. In general, the resin compositions include a photoinitiator that initiates polymerization once exposed to actinic radiation or light (e.g., UV radiation). Photoinitiators included in the polymerizable liquid (resin) can be any suitable photoinitiator, including type I and type II photoinitiators and including commonly used UV photoinitiators, examples of which include but are not limited to acetophenones (diethoxyacetophenone for example), phosphine oxides such as diphenyl(2,4,6-trimethylbenzoyl) phosphine oxide, phenylbis(2,4,6-trimethylbenzoyl) phosphine oxide (PPO), Irgacure® 369 (Omnirad® 369, IGM Resins, Charlotte, North Carolina, U.S.A.) (2-benzyl-2-(dimethylamino)-4′-morpholinobutyrophenone, CAS number 119313 Dec. 1), etc. See, e.g., U.S. Pat. No. 9,453,142, incorporated by reference in its entirety, for other non-limiting examples.

While in some embodiments, the resin compositions of the invention are devoid or substantially devoid of fillers that are not covalently bound to a reactive compound, in some embodiments, free or non-covalently bound filler may be present in the resin composition. As such, in some embodiments, the resin compositions further include solid particles suspended or dispersed therein. Any suitable solid particle can be used, depending upon the three-dimensional object being fabricated. In some embodiments, the particles are metallic, organic/polymeric, inorganic, or composites or mixtures thereof. For example, the particles may be nonconductive, semi-conductive, or conductive (including metallic and non-metallic or polymer conductors); and the particles can be magnetic, ferromagnetic, paramagnetic, or nonmagnetic. The particles can be of any suitable shape, including spherical, elliptical, cylindrical, etc. In some embodiments, the particles may include an active agent or detectable compound, though these may also be provided dissolved solubilized in the liquid resin as also discussed below. In a particular embodiment, magnetic or paramagnetic particles or nanoparticles can be employed. The filler particles included in the resin compositions may be of any suitable size (for example, about 1 nm to about 20 μm average diameter).

In embodiments wherein a free filler (not covalently bound) is present in the composition, such fillers may include reactive and non-reactive rubbers, siloxanes, acrylonitrile-butadiene rubbers, reactive and non-reactive thermoplastics (including but not limited to: poly(ether imides), maleimide-styrene terpolymers, polyacrylates, polysulfones and polyethersulfones, etc.) inorganic fillers such as silicates (such as talc, clays, silica, mica), glass, carbon nanotubes, graphene, cellulose nanocrystals, etc., including combinations of all of the foregoing. Suitable fillers include tougheners, such as core-shell rubbers, as discussed below. Such fillers may also be used, in some embodiments, as a filler moiety that is attached to a reactive compound.

One or more polymeric and/or inorganic tougheners can be used as a filler in some embodiments of the present invention. The toughener may be uniformly distributed in the form of particles in the cured product. In some embodiments, such particles are less than about 5 microns (μm) in diameter. Such tougheners include, but are not limited to, those formed from elastomers, branched polymers, hyperbranched polymers, dendrimers, rubbery polymers, rubbery copolymers, block copolymers, core-shell particles, oxides or inorganic materials such as clay, polyhedral oligomeric silsesquioxanes (POSS), carbonaceous materials (e.g., carbon black, carbon nanotubes, carbon nanofibers, fullerenes), ceramics and silicon carbides, with or without surface modification or functionalization. Such fillers may also be used, in some embodiments, as a filler moiety that is attached to a reactive compound.

Core-shell rubbers are particulate materials (particles) having a rubbery core. Such materials are known and described in, for example, U.S. Patent Application Publication Nos. 2015/0184039 and 2015/0240113, and U.S. Pat. Nos. 6,861,475, 7,625,977, 7,642,316, and 8,088,245. In some embodiments, the core-shell rubber particles are nanoparticles (i.e., having an average particle size of less than about 1000 nm). Generally, the average particle size of the core-shell rubber nanoparticles is less than about 500 nm, e.g., less than about 300 nm, less than about 200 nm, less than about 100 nm, or even less than about 50 nm. Suitable core-shell rubbers include, but are not limited to, those sold by Kaneka Corporation (Pasadena, Texas, U.S.A.) under the designation Kaneka Kane Ace™, including the Kaneka Kane Ace™ 15 and 120 series of products, including Kaneka Kane Ace™ MX 120, Kaneka Kane Ace™ MX 153, Kaneka Kane Ace™ MX 154, Kaneka Kane Ace™ MX 156, Kaneka Kane Ace™ MX170, Kaneka Kane Ace™ MX 257 and Kaneka Kane Ace™ MX 120 core-shell rubber dispersions, and mixtures thereof. In some embodiments, the resin compositions are devoid of core-shell rubbers.

In some embodiments, the resin composition may have additional ingredients solubilized therein, including active compounds, pharmaceutical compounds, detectable compounds (e.g., fluorescent, phosphorescent, radioactive), etc., depending upon the particular purpose of the three-dimensional object being fabricated. Examples of such additional ingredients include, but are not limited to, proteins, peptides, nucleic acids (DNA, RNA) such as siRNA, sugars, small organic compounds (drugs and drug-like compounds), and the like, including combinations thereof. In particular embodiments, the resin compositions may include pigments and/or dyes including pigments and/or dyes that are solubilized in the resin composition. As described elsewhere herein, however, in some embodiments, the resin composition is devoid or substantially devoid of such pigments and/or dyes.

In some embodiments, the resin compositions may include one or more polymerization (or other reaction) inhibitors, including liquid or gas inhibitors. The specific inhibitor will depend upon the monomer being polymerized and the polymerization reaction. For free radical polymerization monomers, in some cases, the inhibitor is oxygen, which can be provided in the form of a gas such as air, a gas enriched in oxygen (optionally including an inert gas with oxygen to reduce combustibility thereof), or pure oxygen gas. In alternate embodiments, such as where the monomer is polymerized by a photoacid generator initiator, the inhibitor may include a base such as ammonia, amine(s) (e.g., methyl amine, ethyl amine, di and trialkyl amines such as dimethyl amine, diethyl amine, trimethyl amine, triethyl amine, etc.), and/or carbon dioxide.

In some embodiments, resins for carrying out the present invention include a non-reactive pigment or dye that absorbs light, particularly UV light. Suitable examples of such light absorbers include, but are not limited to: (i) titanium dioxide (e.g., included in an amount of from about 0.05 or about 0.1 to about 1 or about 5 percent by weight), (ii) carbon black (e.g., included in an amount of from about 0.05 or about 0.1 to about 1 or about 5 percent by weight), and/or (iii) an organic ultraviolet light absorber such as a hydroxybenzophenone, hydroxyphenylbenzotriazole, oxanilide, benzophenone, thioxanthone, hydroxyphenyltriazine, and/or benzotriazole ultraviolet light absorber (e.g., Mayzo BLS1326 (Mayzo Specialty Chemicals Plus, Suwanee, Georgia, U.S.A.)) (e.g., included in an amount of about 0.001 or about 0.005 to about 1, about 2 or about 4 percent by weight). Examples of suitable organic ultraviolet light absorbers include, but are not limited to, those described in U.S. Pat. Nos. 3,213,058; 6,916,867; 7,157,586; and 7,695,643, the disclosures of which are incorporated herein by reference. As described elsewhere herein, in some embodiments of the invention, the resin compositions are devoid or substantially devoid of such non-reactive pigments or dyes.

In some embodiments of the invention, the resin compositions include one or more metal organometallic chelate catalysts, including tin and non-tin catalysts. Such catalysts are known and described in, for example, U.S. Pat. Nos. 5,965,686, 8,912, 113, 9,066,316, and 10,023,764; and in W. Blank et al., Catalysis of the Isocyanate-Hydroxyl Reaction by Non-Tin Catalysts (1999); W. Blank et al., Catalysis of Blocked Isocyanates with Non-Tin Catalysts (2000); and J. Florio et al., Novel Bismuth Carboxylate Catalysts with Good Hydrolytic Stability and HFO Compatibility (2017). Particular examples of suitable catalysts include but are not limited to K-KAT® catalysts 4205, XK-348, XK-635, XK-651, XK-661, XK-672, and XK-678, available from King Industries, 1 Science Road, Norwalk, Conn. 06852 USA.

In addition to the catalysts described above, additional constituents for a dual cure resin of the present invention are described in, for example, in U.S. Pat. Nos. 9,453,142, 9,598,606, 9,676,963, and 9,982, 164.

In some embodiments, the resin compositions of the invention may be packaged as two separate precursors, which are mixed together and dispensed prior to use (sometimes referred to as “2K resins”). In some embodiments, the resin composition may be packaged in a premixed form in the same chamber of a single container (sometimes referred to as a “1K” resin).

In some embodiments of the invention, provided are three-dimensional objects formed from a resin composition of the invention. Such objects include a filler moiety covalently bonded to a polymer chain and/or network that forms the three-dimensional object.

### ADDITIVE MANUFACTURING METHODS

Resin compositions of the invention may be used to form three-dimensional objects by a variety of additive manufacturing methods. Techniques for additive manufacturing are known. Suitable techniques include bottom-up and top-down additive manufacturing, generally known as stereolithography. Such methods are known and described in, for example, U.S. Pat. Nos. 5,236,637, 5,391,072, 5,529,473, 7,438,846, 7,892,474, 8, 110,135, 9,636,873, and 9,120,270.

Continuous Liquid Interface Production (CLIP) is known and described in, for example, U.S. Pat. Nos. 9,211,678, 9,205,601, and 9,216,546; and also in J. Tumbleston, D. Shirvanyants, N. Ermoshkin et al., Continuous liquid interface production of 3D Objects, Science 347, 1349-1352 (2015). See also R. Janusziewcz et al., Layerless fabrication with continuous liquid interface production, Proc. Natl. Acad. Sci. USA 113, 11703-11708 (2016). In some embodiments, CLIP employs features of a bottom-up three dimensional fabrication as described above, but the irradiating and/or advancing steps are carried out while also concurrently maintaining a stable or persistent liquid interface between the growing object and the build surface or window, such as by: (i) continuously maintaining a dead zone of polymerizable liquid in contact with said build surface, and (ii) continuously maintaining a gradient of polymerization zone (such as an active surface) between the dead zone and the solid polymer and in contact with each thereof, the gradient of polymerization zone comprising the first component in partially cured form.

In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone. The inhibitor may pass entirely through the semipermeable member, or a “pool” of inhibitor may reside within the semipermeable member and pass through the resin contact surface thereof. While a desirable inhibitor is oxygen, other inhibitors, such as bases (including amines) may also be used. Other approaches for carrying out CLIP that can be used in the present invention and potentially obviate the need for a semipermeable “window” or window structure include utilizing a liquid interface comprising an immiscible liquid (see e.g., U.S. Pat. No. 10,434,706) and generating oxygen as an inhibitor by electrolysis (see, e.g., U.S. Pat. No. 11,000,992).

After the intermediate three-dimensional object is formed, it is optionally washed, optionally dried (e.g., air dried) and/or rinsed (in any sequence). In some embodiments (employing “dual cure” resins), it is then further cured, such as by heating. Heating may be active heating (e.g., baking in an oven, such as an electric, gas, solar oven or microwave oven, or combination thereof), or passive heating (e.g., at ambient (room) temperature). Active heating will generally be more rapid than passive heating and in some embodiments is preferred, but passive heating—such as simply maintaining the intermediate at ambient temperature for a sufficient time to effect further cure—may in some embodiments also be employed. In some embodiments, the three-dimensional intermediate may alternatively or additionally be cured by microwave irradiation, irradiation at a same or different wavelength than that used during the formation of the three-dimensional intermediate, and/or via exposure to moisture.

In some embodiments, methods of the invention include the steps of (a) providing a carrier and an optically transparent member having a build surface, the carrier and the build surface defining a build region therebetween; (b) filling the build region with a resin composition of the invention; (c) irradiating the build region with light through the optically transparent member to solidify at least a portion of the resin composition in contact with the carrier; (d) advancing said carrier away from the build surface; (e) repeating steps (b) through (d) to form a solid polymer scaffold; and (f) optionally, washing the solid polymer scaffold, thereby forming the three-dimensional object.

In some embodiments, the solid polymer scaffold is a three-dimensional intermediate having the same shape as, or a shape to be imparted to, the three-dimensional object, and the three-dimensional intermediate is further reacted to form the three-dimensional object. In some embodiments, further reacting comprises heating, microwave irradiation, irradiation at a same or different wavelength than in step (c), and/or exposure to moisture. In some embodiments, the resin composition is a dual cure resin and wherein the three-dimensional intermediate carries unsolidified and/or uncured resin with the solid polymer scaffold and the further reacting solidifies the unsolidified and/or uncured resin. In some embodiments, further reacting is carried out under conditions in which the polymer scaffold degrades and forms a constituent necessary for the solidification or curing of the unsolidified and/or uncured resin.

In some embodiments of the invention, step (b) and/or step (c) is carried out while also concurrently (i) continuously maintaining a dead zone of the resin composition in contact with the build surface; and (ii) continuously maintaining a gradient of polymerization zone between the dead zone and the solidified polymer in contact with the carrier, the gradient of polymerization zone comprising the resin composition in partially cured form. In some embodiments, the optically transparent member includes a semipermeable member (optionally wherein the semipermeable member comprises a fluoropolymer), and continuously maintaining a dead zone is carried out by feeding an inhibitor (e.g., oxygen) through said optionally transparent member (optionally creating a gradient of inhibitor in the dead zone and optionally in at least a portion of the gradient of polymerization zone).

The present invention is further described in the following non-limiting examples.

### EXAMPLES

In Examples 1-4 and Comparative Examples 1-4, the following materials and abbreviations are used:

| | |
|---|---|
| HMDI | Methylene bis(4-cyclohexylisocyanate) (Wannate H1210, |
| | Wanhua) |
| PTMEG 1000 | Poly(tetrahydrofuran) ~1000 Mn (Sigma Aldrich) |
| Pluracol 4600 | SAN-graft polyether triol, ~5300 MW, 3 eq. OH- |
| | functional (BASF) |
| MEHQ | 4-methoxyphenol (Sigma Aldrich) |
| XK-651 | K-KAT XK-651 (a bismuth carboxylate, King Industries) |
| BHT | 2,6-di-tert-butyl-4-methylphenol (Sigma Aldrich) |
| TBAEMA | 2-(tert-butylamino)ethyl methacrylate (Novasol) |
| SR313B | C12-C14 alkyl methacrylate (Sartomer) |
| SR252 | Poly(ethylene glycol) 600 MW dimethacrylate (Sartomer) |
| Irganox 245 | Ethylene bis(oxyethylene) bis-(3-(5-tert-butyl-4-hydroxy- |
| | m-tolyl)propionate) (BASF Corporation) |
| TPO | Diphenyl(2,4,6-trimethylbenzoyl)phosphine oxide (PL |
| | Industries) |
| MACM | 4,4′-methylenebis(2-methylcyclohexylamine) (DKSH) |
| ABPU | (meth)acrylate blocked polyurethane |
| NCO | Isocyanate group |
| ATR-FTIR | Attenuated total reflectance - Fourier transform infrared |

### Comparative Example 1—Synthesis of Acrylate-Blocked Polyurethane (ABPU) Control

In a reactor containing XK-651 (0.213 g) and HMDI (390.63 g) at 70° C., PTMEG 1000 (674.32 g) was added over a one-hour period and continuously mixed under dry air. After 25 minutes of mixing, MEHQ (0.302 g) and BHT (0.302 g) were added and then temperature was lowered to 50° C. for one hour. TBAEMA (299.90 g) was fed into the reactor over 2 hours and the temperature was raised to 60° C. for one hour. The temperature was lowered to 40° C. and the ATR-FTIR spectrum was measured with a Bruker Alpha spectrometer, confirming reaction completion (the NCO content was below 0.1%) of ABPU. The viscosity at 25° C. was measured to be 818,400 cP using a Brookfield viscometer (Model DV1). The liquid was clear and transparent, with a haze value of 0.25%, measured with a 20-mm path-length sample on a Hunterlab ColorQuest XE spectrophotometer.

### Example 1—Synthesis of Novel ABPU with Covalently Attached Filler

In a reactor containing XK-651 (0.231 g) and HMDI (408.51 g) at 70° C., a blend of PTMEG 1000 (691.26 g) and Pluracol 4600 (55.69 g) were added over a 105-minute period and continuously mixed under dry air. After 30 minutes of mixing, MEHQ (0.325 g) and BHT (0.326 g) were added and then the temperature was lowered to 50° C. for one hour. TBAEMA (313.05 g) was fed into the reactor over 105 minutes and the temperature was raised to 60° C. for one hour. The temperature was lowered to 50° C. and the ATR-FTIR spectrum was measured with a Bruker Alpha spectrometer, confirming reaction completion (the NCO content was below 0.1%) of ABPU Example 1. The viscosity at 25° C. was measured to be 814,800 cP using a Brookfield viscometer (Model DV1). The liquid was hazy/opaque white, with a haze value of 97.94%, measured with a 20-mm path-length sample on a Hunterlab ColorQuest XE spectrophotometer.

TABLE 1
Composition summary of ABPU examples in parts
per hundred (pph) and characteristics

| | Comp. | |
|---|---|---|
| | Example 1 | Example 1 |
| | ABPU | ABPU |
| Component (pph) | | |
| HMDI | 28.60 | 27.80 |
| XK-651 | 0.016 | 0.016 |
| PTMEG 1000 | 49.38 | 47.04 |
| Pluracol 4600 | — | 3.790 |
| MEHQ | 0.022 | 0.022 |
| BHT | 0.022 | 0.022 |
| TBAEMA | 21.96 | 21.30 |
| Characterization | | |
| Viscosity at 25° C. (cP) | 818,400 | 814,800 |
| Haze | 0.25% | 97.94% |

### Comparative Example 2—Control Part A Resin Formulation

In a Flack Tek SpeedMixer cup was added the ABPU from Comparative Example 1 (367.01 g), Irganox 245 (0.499 g), TPO (7.49 g), SR252 (25.01 g), and SR313B (100.01 g). The cup was closed and FlackTek mixed at 2000 rpm for 30 minutes to produce the Comparative Example 2 Part A resin, which was visually transparent and colorless. The viscosity at 25° C. was measured to be 13,400 cP using a Brookfield viscometer (Model DV1).

### Example 2—Part A Resin Formulation with Covalently Bonded Filler

In a FlackTek SpeedMixer cup was added ABPU from Example 1 (367.00 g), Irganox 245 (0.501 g), TPO (7.50 g), SR252 (25.01 g), and SR313B (100.00 g). The cup was closed and FlackTek mixed at 2000 rpm for 30 minutes to produce the Example 2 Part A resin, which was visually opaque and white. The viscosity at 25° C. was measured to be 13,080 cP using a Brookfield viscometer (Model DV1).

TABLE 2
Composition summary of Part A formulation
examples in pph and characteristics

| | COMP. | |
|---|---|---|
| | EXAMPLE 2 | EXAMPLE 2 |
| | PART A | PART A |
| COMPONENT (PPH) | | |
| Comp. Ex. 1 ABPU | 73.40 | — |
| Ex. 1 ABPU | — | 73.40 |
| Irganox 245 | 0.10 | 0.10 |
| TPO | 1.50 | 1.50 |
| SR252 | 5.00 | 5.00 |
| SR313B | 20.00 | 20.00 |
| Characterization | | |
| Viscosity at 25° C. (cP) | 13,400 | 13,080 |

### Comparative Example 3—Control Part A+B Resin Printing and Mechanical Testing

In a planetary centrifugal mixer cup (THINKY for viscosity measurements and FlackTek SpeedMixer for printing resin) was added Comparative Example 2 Part A resin and MACM and mixed for 8 minutes at 2000 rpm. The viscosity at 40° C. was measured to be 3,050 cP using a Brookfield viscometer (Model DV1). This Comparative Part A+B resin blend was then printed on a Carbon, Inc. M2 additive manufacturing apparatus at 40° C. to produce 2-mm thick slabs as well as a 6-mm thick slab. The slabs were wiped dry with blue paper towels and then baked in an air oven at 120° C. for 8 hours. The 2-mm thick slabs were die-cut into ASTM D 412 dog-bone specimen using Die C and tested for mechanical tensile properties with a 500 mm/min strain rate. The 6-mm thick slab was tested with a Shore A durometer. The tested properties are shown in Table 3.

### Example 3—Covalently Bound Filler Part A+B Resin Printing and Mechanical Testing

In a planetary centrifugal mixer cup (THINKY for viscosity measurements and FlackTek SpeedMixer for printing resin) was added Example 2 Part A resin and MACM and mixed for 8 minutes at 2000 rpm. The viscosity at 40° C. was measured to be 3,100 cP using a Brookfield viscometer (Model DV1). This Part A+B resin blend was then printed on a Carbon, Inc. M2 additive manufacturing apparatus at 40° C. to produce 2-mm thick slabs as well as a 6-mm thick slab. The slabs were wiped dry with blue paper towels and then baked in an air oven at 120° C. for 8 hours. The 2-mm thick slabs were die-cut into ASTM D 412 dog-bone specimen using Die C and tested for mechanical tensile properties with a 500 mm/min strain rate. The 6-mm thick slab was tested with a Shore A durometer. The tested properties are shown in Table 3.

TABLE 3
Composition summary and viscosity of Part A + B resins
as well as final printed and baked mechanical properties

| | COMP. | EXAMPLE 3 - |
|---|---|---|
| | EXAMPLE 3 - | BONDED |
| | CONTROL | FILLER |
| COMPONENT (PPH) | | |
| Part A - Comp. Ex. 2 | 90.6 | — |
| Part A - Ex. 2 | — | 90.9 |
| Part B - MACM | 9.4 | 9.1 |
| Liquid Part A + B | | |
| Characterization | | |
| Viscosity at 40° C. (cP) | 3,050 | 3,100 |
| Final Mechanical Property | | |
| Shore A | 90 | 88 |
| Chord Modulus, 1-5% (MPa) | 38.5 | 37.2 |
| Elongation at Break (%) | 318 | 330 |
| Ultimate Tensile Strength (MPa) | 26.0 | 26.8 |
| Visual Appearance | Colorless, | White, |
| | transparent | opaque |

Table 3 shows that the novel covalently bonded filler polyurethane can match the performance of a PTMEG-only polyol sample (control) while also being able to also add filler and light scattering dispersion additives (tunable opacity and print accuracy). The covalently bonded filler polyol used in this work has a functionality of 3, which also allows control over the crosslinking density.

### Comparative Example 4—Storage Stability of Control

A portion of the ABPU in Comparative Example 1 was kept in a closed container at 30° C. for 87 days and then centrifuged for 12 minutes at 6000 rpm (relative centrifugal force of 4430 ×g) using a Labnet Hermle Z 206 A. The viscosity at 25° C. was measured to be 841,200 cP using a Brookfield viscometer (Model DV1). The liquid was clear and transparent, with a haze value of 1.98%, measured with a 20-mm path-length sample on a Hunterlab ColorQuest XE spectrophotometer.

### Example 4—Storage Stability of Covalently Bonded Filler PU Resin

A portion of the ABPU in Example 1 was kept in a closed container at 30° C. for 87 days and then centrifuged for 12 minutes at 6000 rpm (relative centrifugal force of 4430 ×g) using a Labnet Hermle Z 206 A. The viscosity at 25° C. was measured to be 852,600 cP using a Brookfield viscometer (Model DV1). The liquid was hazy/opaque white, with a haze value of 98.58%, measured with a 20-mm path-length sample on a Hunterlab ColorQuest XE spectrophotometer.

TABLE 4
Storage stability of control and filler-grafted ABPUs

| | CONTROL | | BONDED FILLER PU | |
|---|---|---|---|---|
| | | After | | After |
| CHARAC- | Initial | 87 days | Initial | 87 days |
| TERISTIC | (Comp. | (Comp. | (Exam- | (Exam- |
| Condition | Ex 1) | Ex. 4) | ple 1) | ple 4) |
| Viscosity at | 818,400 | 841,200 | 814,800 | 852,600 |
| 25° C. (cP) | | | | |
| Haze | 0.25% | 1.98% | 97.94% | 98.58% |

As shown in Table 4, the control and covalently bonded filler samples show minimal change in viscosity after storage, meaning the covalently bonded filler does not negatively impact viscosity stability. Similarly, the haze value did not drop, indicative of a stable filler and light scattering dispersion in the covalently bonded filler sample. Both the control and covalently bonded filler sample had similar, minor increases in haze.

The foregoing experiments demonstrate that a portion of a polyol used to form a reactive blocked polyurethane may be substituted with a covalently bonded filler polyol (in total, the formulation described contains ˜2.5% filler polyol, which translates to ˜1.1% SAN filler total) and used as a resin in an additive manufacturing process. The liquid properties of the resin and mechanical properties of the graft formulation are comparable to the control formulation but allow for the control of the visual appearance (e.g., from colorless and transparent to an opaque or milky white). Because the graft polyol, which contains a covalently-bound SAN particle, is also bound into the ABPU, no significant flocculation or sedimentation of the fillers should occur, which is supported by the stability data shown herein. These experiments demonstrate that the control of the white opacity of the final printed parts may be achieved without the use of TiO₂, silica, or other unbound solid particles. This may also provide final printed parts that have equivalent or potentially improved mechanical properties. Additionally, the synthesis and incorporation of these graft polyols did not require high shear mixing, which is typically required for the use of traditional solid fillers or pigments. As such, the present invention may also greatly simplify manufacturing equipment and processes needed for production.

The foregoing is illustrative of the present invention, and is not to be construed as limiting thereof. The invention is defined by the following claims, with equivalents of the claims to be included therein.

We claim:

1. A resin composition useful for producing a three-dimensional object by additive manufacturing comprising
at least one reactive compound having a filler moiety covalently attached thereto, wherein the reactive compound is selected from the group consisting of a monomer, prepolymer, a chain extender, and a reactive diluent.

2. The resin composition of claim 1, wherein the filler moiety scatters light in a range of about 100 nm to about 700 nm.

3. The resin composition of claim 1, wherein the filler moiety has an average diameter in a range of about 0.02 μm to about 200 μm.

4. The resin composition of claim 1, wherein the filler moiety is an organic filler moiety.

5. The resin composition of claim 1, wherein the filler moiety is an inorganic filler moiety.

6. The resin composition of claim 1, wherein the resin composition comprises precursors to a polyurethane, polyurea, polyisocyanurate, a silicone, an epoxy, a cyanate ester, or a combination of any of the foregoing.

7. The resin composition of claim 1, wherein the reactive compound comprises a light polymerizable monomer.

8. The resin composition of claim 1, wherein the reactive compound comprises a prepolymer and/or chain extender and at least a portion of the resin composition reacts to form a polyurethane, polyurea, a polyisocyanurate, or any combination thereof.

9. The resin composition of claim 8, wherein the prepolymer is a blocked or reactive blocked prepolymer and/or the chain extender is a blocked or reactive blocked chain extender.

10. The resin composition of claim 8, wherein the chain extender comprises a polyamine and/or a polyol.

11. The resin composition of claim 8, wherein the resin comprises:
(a) the reactive compound, wherein the reactive compound is a reactive blocked prepolymer having the filler moiety covalently attached thereto;
(b) a chain extender;
(c) a photoinitiator; and
(d) optionally, a reactive diluent.

12. The resin composition of claim 1, wherein the resin composition is devoid or substantially devoid of one or more of: (a) a filler that is not covalently bound to a reactive compound, (b) a pigment that is not bound to a reactive compound, and (c) a dye that is not bound to a reactive compound.

13. The resin composition of claim 1, wherein the resin composition comprises a reactive blocked polyurethane prepolymer having an organic filler moiety covalently attached thereto; a di(meth)acrylate; a (meth)acrylate diluent; a polyamine or polyol; and a photoinitiator, and wherein the organic filler moiety is a copolymer comprising styrene and acrylonitrile units.

14. A method of forming a three-dimensional object, comprising:
irradiating the resin composition of claim 1 with actinic radiation or light, thereby forming the three-dimensional object.

15. A method of forming a three-dimensional object, comprising:
(a) providing a carrier and an optically transparent member having a build surface, the carrier and the build surface defining a build region therebetween;
(b) filling the build region with the resin composition of claim 1;
(c) irradiating the build region with light through the optically transparent member to solidify at least a portion of the resin composition;
(d) advancing said carrier away from the build surface;
(e) repeating steps (b) through (d) to form a solid polymer scaffold; and
(f) optionally, washing the solid polymer scaffold,
thereby forming the three-dimensional object.

16. The method of claim 15, wherein the solid polymer scaffold is a three-dimensional intermediate having the same shape as, or a shape to be imparted to, the three-dimensional object, and wherein the three-dimensional intermediate is further reacted to form the three-dimensional object.

17. The method of claim 16, wherein further reacting comprises heating, microwave irradiation, irradiation at a same or different wavelength than in step (c), and/or exposure to moisture.

18. The method of claim 16, wherein the resin composition is a dual cure resin and wherein the three-dimensional intermediate carries a component of the resin in unsolidified and/or uncured resin form within the solid polymer scaffold and the further reacting solidifies and/or cures the unsolidified and/or uncured resin, optionally wherein the further reacting is carried out under conditions in which the solid polymer scaffold degrades and forms a constituent necessary for the solidification or curing of the unsolidified and/or uncured resin.

19. The method of claim 15, wherein step (b) and/or step (c) is carried out while also concurrently (i) continuously maintaining a dead zone of the resin composition in contact with the build surface; and (ii) continuously maintaining a gradient of polymerization zone between the dead zone and the solidified polymer in contact with the carrier, the gradient of polymerization zone comprising the resin composition in partially cured form.

20. A three-dimensional object formed from a resin composition of claim 1.
